(19) United States
(12) Patent Application Publication
(10) Pub. No.: US 2005/0159157 A1
(43) Pub. Date: Jul. 21, 2005

(54) Authentications in a communication system

(75) Inventor: Gabor Bajko, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/017,761

(22) Filed: Dec. 22, 2004

(30) Foreign Application Priority Data
Jan. 20, 2004 (FI) 20040076

(51) Int. Cl. H04Q 7/20

(52) U.S. Cl. 455/435.1; 455/411

(57) ABSTRACT

A method and communication system for authentication of requests are disclosed. In the method, a user equipment is authenticated during a registration to a controller. At least two registration requests may be received at the controller, with at least one of the registration requests originating from another source than the user equipment. Authentication of the received registration requests may be initiated regardless of the origin of the requests. The user equipment is registered in response to a request from an already authenticated user equipment.

### BACKGROUND OF THE INVENTION

1. Field of the Invention

The present invention relates to communication systems, and in particular, to authentications in a communication system. Authentication may be required, for example, before requests for registrations are completed.

2. Description of the Related Art

A communication system can be seen as a facility that enables communication sessions between two or more entities such as user equipment and/or other nodes associated with the communication system. The communication may comprise, for example, communication of voice, data, multimedia and so on. A user equipment may, for example, be provided with a two-way telephone call or multi-way conference call. A user equipment may also be provided with a connection to an application server (AS), for example a service provider server, thus enabling use of services provided by the application server.

A communication system typically operates in accordance with a given standard or specification which sets out what the various entities associated with the communication system are permitted to do and how that should be achieved. For example, the standard or specification may define if the user, or more precisely, user equipment is provided with a circuit switched service and/or a packet switched service. Communication protocols and/or parameters which shall be used for the connection may also be defined. In other words, a specific set of “rules” on which the communication can be based on needs to be defined to enable communication by means of the system.

Communication systems proving wireless communication for user equipment are known. An example of the wireless systems is the public land mobile network (PLMN). Another example is a mobile communication system that is based, at least partially, on use of communication satellites. Wireless communications may also be provided by means of other arrangements, such as by means of wireless local area networks (WLAN). Communication on the wireless interface between the user equipment and the elements of the communication network can be based on an appropriate communication protocol. The operation of the station apparatus of the communication system and other apparatus required for the communication can be controlled by one or several control entities. The various control entities may be interconnected. One or more gateway nodes may also be provided for connecting a communication network to other networks. For example, a mobile network may be connected to communication networks such as an IP (Internet Protocol) and/or other packet switched data networks.

An example of the services that may be offered for users of a communication system is the so called multimedia services. An example of the communication systems enabled to offer multimedia services is the Internet Protocol (IP) Multimedia network. IP Multimedia (IM) functionalities can be provided by means of a IP Multimedia Core Network (CN) subsystem, or briefly IP Multimedia subsystem (IMS). The IMS includes various network entities for the provision of the multimedia services.

The Third Generation Partnership Project (3GPP) has defined use of the General Packet Radio Service (GPRS) as a backbone communication system for the provision of the IMS services, the GPRS being given herein as a non-limiting example of a possible backbone communication system enabling the multimedia services. The Third Generation Partnership Project (3GPP) has also defined a reference architecture for the third generation (3G) core network which will provide the users of user equipment with access to the multimedia services. This core network is divided into three principal domains. These are the Circuit Switched (CS) domain, the Packet Switched (PS) domain and the Internet Protocol Multimedia (IM) domain.

The IM domain is for ensuring that multimedia services are adequately managed. A user who wishes use IMS services needs to be registered to a serving controller provided in the IM domain. A user may register by sending a request for registration to a serving controller of an IMS network. The request may be routed to the serving controller via one or more proxy controllers. A serving controller may send in response to a request for registration a challenge. The user then needs to respond the challenge in a predefined manner.

The 3G IM domain supports the Session Initiation Protocol (SIP) as developed by the Internet Engineering Task Force (IETF). SIP ‘REGISTER’ request is an example of a possible protocol message for such as registration request. Session Initiation Protocol (SIP) is an application-layer control protocol for creating, modifying and terminating sessions with one or more participants (endpoints).

It is expected that various types of services are to be provided by means of different Application Servers (AS) over IMS systems. For the services it may not be enough just to rely on the assumption that a user equipment or any other node requesting for registration is genuine and can be trusted. Therefore various data security mechanisms may be used when providing services over the communication system.

Authentication of users is a typical security mechanism. Authentication may be used for verifying the authenticity of data, for example, that data is correct and comes from an appropriate source. Authentication may be required, for example, for securing data and the integrity of a user against attacks during transportation of data over a data network. Other examples include authentication for preventing non-authorised users from accessing data that is stored in a database and authentication for preventing unauthorised use of services.

Lets now consider a situation wherein a genuine user is successfully registered with the network. The user is authenticated during the registration process. The genuine user may use an appropriate security protocol, such as by an Internet Protocol security mechanism known as IPsec, to integrity protect any further messages it sends to the network. A user can only register for a certain time, and thus at some point it may need to refresh the registration thereof. This is typically performed by sending a re-registration request. The re-registration request may also be protected using IPsec.

Certain standards state that the network shall challenge every request for registration and forget any previously sent challenges if a new request for registration is received before receipt of a response to the challenge. This means that if there is an active attacker continuously sending requests for registrations in the name of a genuine user to the network, this may prevent the genuine user to register with the network. This may be so since every request for registration sent by the genuine user might be followed by a fake request for registration by the attacker before the genuine user could respond to the challenge and gets authenticated. When an attacker sends an unprotected register in the name of the user right after the user sends a protected request, the network challenges the unprotected register and invalidates the challenge sent to the protected request for registration. Because of this the already registered user may not be able to extend its registration time, but is instead deregistered and disconnected from the network. Thus the user would experience discontinuity in the service.

The current mechanism may be misused for denial of service type attacks by a malicious user who may be repeatedly sending register requests while pretending to be another subscriber. In such cases, the requests by the genuine user may be discarded because of requests from the malicious user who keeps sending them without being able or even wishing to be authenticated.

A timer may be set for the receipt of an authentication response. For example, in the 3GPP IMS the timer is typically set to approximately 4 minutes. During this period an error message may be generated in response to any subsequent requests by the genuine subscriber. This may allow an attacker to block services from the genuine user, even if the attacker is not actively sending malicious requests all the time. The genuine user will only receive an error message, and the user is not allowed to register once an attacker initiated a registration. Alternatively, instead of an error message, the request might be answered with an authentication challenge. The challenge may, however, be invalidated, i.e. a response thereof is no longer accepted, even if it could be a proper response by the network when a yet another request is received either from the attacker or the genuine user.

### SUMMARY OF THE INVENTION

Embodiments of the present invention aim to address one or several of the above problems.

According to one embodiment of the present invention, there is provided a method in a communication system for authentication of requests. In the method a user equipment is authenticated during a registration to a controller. At least two registration requests may then be received at the controller, at least one of the registration requests originating from another source than the user equipment. Authentication of the received at least two registration requests may be initiated regardless the origin of the requests. The user equipment is registered in response to a request from an already authenticated user equipment.

According to another embodiment there is provided a controller for a communication system. The controller is configured to authenticate user equipments that have sent initial registration requests to the controller, to receive further registration requests, at least one of the further registration requests originating from another source than an authenticated user equipment, to initiate authentication of the received at least two further registration requests, and to register user equipment only in response to further requests from authenticated user equipment.

According to another embodiment there is provided a communication system for providing user equipments with services comprising a controller as described above.

Embodiments may provide a way of preventing attacker from blocking a genuine user from using services, and from disturbing use of services by a genuine user.

### BRIEF DESCRIPTION OF THE DRAWINGS

For better understanding of the present invention, reference will now be made by way of example to the accompanying drawings in which:

FIG. 1 shows one embodiment of the invention; and

FIG. 2 is a flowchart illustrating the operation of one embodiment of the invention.

### DETAILED DESCRIPTION OF THE PREFERRED EMBODIMENTS

Certain embodiments of the present invention will be described in the following by way of example, with reference to the exemplifying architecture of a third generation (3G) mobile communications system. However, it shall be appreciated that the embodiments may be applied to any suitable communication system.

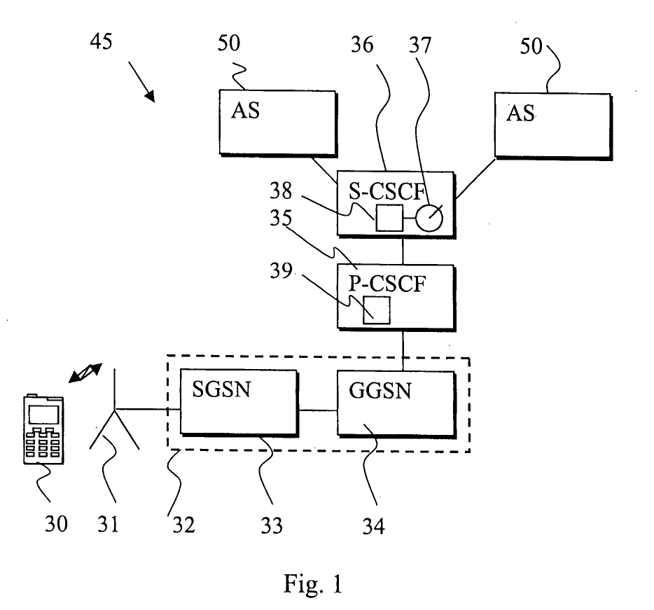

Reference is made to FIG. 1 which shows an example of a network architecture wherein the invention may be embodied. In FIG. 1 an IP Multimedia Network 45 is provided for offering IP multimedia services for IP Multimedia Network subscribers.

As described above, access to IP Multimedia (IM) services can be provided by means of a mobile communication system. A mobile communication system is typically arranged to serve a plurality of mobile user equipment usually via a wireless interface between the user equipment and at least one base station 31 of the communication system. The mobile communication system may logically be divided between a radio access network (RAN) and a core network (CN).

The base station 31 is arranged to transmit signals to and receive signals from a mobile user equipment 30 via a wireless interface between the user equipment and the radio access network. Correspondingly, the mobile user equipment 30 is able to transmit signals to and receive signals from the radio access network via the wireless interface.

In the shown arrangement the user equipment 30 may access the IMS network 45 via the access network associated with the base station 31. It shall be appreciated that, although, for clarity reasons FIG. 1 shows a base station of only one radio access network, a typical communication network system usually includes a number of radio access networks.

The 3G radio access network (RAN) is typically controlled by appropriate radio network controller (RNC). This controller is not shown in order to enhance clarity. A controller may be assigned for each base station or a controller can control a plurality of base stations, for example in the radio access network level. It shall be appreciated that the name, location and number of the radio network controllers depends on the system.

The mobile user equipment 30 of FIG. 1 may comprise any appropriate mobile user equipment adapted for Internet Protocol (IP) communication to connect the network. For example, the mobile user may access the cellular network by means of a Personal computer (PC), Personal Data Assistant (PDA), mobile station (MS) and so on. The following examples are described with reference to mobile stations.

One skilled in the art is familiar with the features and operation of a typical mobile station. Thus, it is sufficient to note that the user may use a mobile station for tasks such as for making and receiving phone calls, for receiving and sending data from and to the network and for experiencing multimedia content or otherwise using multimedia services. A mobile station may include an antenna for wirelessly receiving and transmitting signals from and to base stations of the mobile communication network. A mobile station may also be provided with a display for displaying images and other graphical information for the user of the mobile user equipment. Camera means may be provided for capturing still or video images. Speaker means are also typically provided. The operation of a mobile station may be controlled by means of an appropriate user interface such as control buttons, voice commands and so on. Furthermore, a mobile station is provided with a processor entity and a memory means.

It shall be appreciated that although only few mobile stations are shown in FIG. 1 for clarity, a great number of mobile stations may be in simultaneous communication with a communication system.

A core network (CN) typically includes various switching and other control entities and gateways for enabling the communication via a number of radio access networks and also for interfacing a single communication system with one or more communication system such as with other cellular systems and/or fixed line communication systems. In the 3GPP systems the radio access network is typically connected to an appropriate core network entity or entities such as, but not limited to, a serving general packet radio service support node (SGSN) 33. The radio access network is in communication with the serving GPRS support node via an appropriate interface, for example on an Iu interface. The serving GPRS support node, in turn, typically communicates with an appropriate gateway, for example a gateway GPRS support node 34 via the GPRS backbone network 32. This interface is commonly a switched packet data interface.

In a 3GPP network, a packet data session is established to carry traffic flows over the network. Such a packet data session is often referred as a packet data protocol (PDP) context. A PDP context may include a radio bearer provided between the user equipment and the radio network controller, a radio access bearer provided between the user equipment, the radio network controller and the SGSN 33, and switched packet data channels provided between the serving GPRS service node 33 and the gateway GPRS service node 34. Each PDP context usually provides a communication pathway between a particular user equipment and the gateway GPRS support node and, once established, can typically carry multiple flows. Each flow normally represents, for example, a particular service and/or a media component of a particular service. The PDP context therefore often represents a logical communication pathway for one or more flow across the network. To implement the PDP context between user equipment and the serving GPRS support node, at least one radio access bearer (RAB) needs to be established which commonly allows for data transfer for the user equipment. The implementation of these logical and physical channels is known to those skilled in the art and is therefore not discussed further herein.

FIG. 1 shows also a plurality of application servers 50 connected to the exemplifying Internet Protocol (IP) Multimedia network 45. The user equipment 30 may connect, via the GPRS network 32 and an IMS network 45, to at least one of the application servers 50. It shall be appreciated that a great number of application servers may be connected to a data network.

Communication with the application servers is controlled by means of functions of the data network that are provided by appropriate controller entities. For example, in the current third generation (3G) wireless multimedia network architectures it is assumed that several different servers providing various control functions are used for the control. These include functions such as the call session or call state control functions (CSCFs). The call session functions may be divided into various categories. FIG. 1 shows proxy call session control functions (P-CSCF) 35 and 37 and a serving call session control function (S-CSCF) 36. It shall be appreciated that similar functions may be referred to in different systems with different names.

A user who wishes to use services provided by an application server via the IMS system may need first to register with a serving controller, such as the serving call session control function (S-CSCF) 36. The registration is required to enable the user equipment to request for a service from the multimedia system. As shown in FIG. 1, communication between the S-CSCF 36 and the user equipment 30 may be routed via at least one proxy call session control function (P-CSCF) 35. The proxy CSCF 35 thus acts as a proxy which forwards messages from the GGSN 34 to a serving call session control function 36 and vice versa.

In the embodiments it is assumed that a security association is established between a serving controller and a user after a successful registration of the user to the serving controller. All forthcoming requests may then be sent protected from the user to the serving controller. The processing of further request may be based on the assumption that only a genuine user (i.e. a registered ands thus already authenticated user) is able to send security protected requests. If a number of registration requests is received by a serving controller substantially at the same time, authentication may be performed for the protected and unprotected requests. This allows the genuine user to complete registration procedures thereof even if a malicious request is received. This may provide advantage in preventing a genuine user to loose any sessions and/or from registration failures.

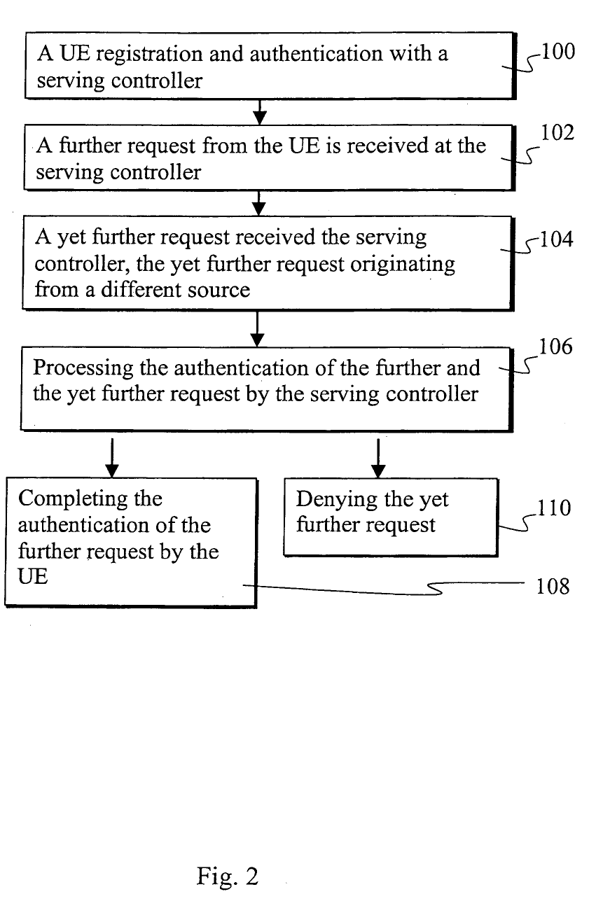

FIG. 2 shows a flowchart for an embodiment. In step 100 a user is registered with a serving controller. Appropriate authentication is performed during the registration. A further request for registration (e.g. re-registration) is then received by the serving controller as step 102. The further request is security protected. It may be assumed at this stage that the further request is from a real user who has already been authenticated at step 100.

At the same time or shortly afterwards an unprotected request for registration may also arrive the serving controller at step 104. Instead of cancelling the earlier request received at step 102, both requests are processed at step 106 until authentication is performed. This may allow the real user's request to succeed (step 108) and the malicious request to fail (step 110).

Referring now again to the communication system of FIG. 1. The S-CSCF 36 may be configured always to check the value of an integrity protected flag inserted into an authorisation header of a registration request message. This may be performed by a processor 38. The flag may be inserted by the P-CSCF 35, for example by processor 39 of the P-CSCF 35. The flag can be used to indicate whether the request was sent integrity protected or without integrity protection.

The S-CSCF 36 may then challenge the request regardless of whether it was received protected or not. The S-CSCF 36 may be provided with an authentication time 37. On contrary to conventional arrangements wherein the S-CSCF 36 invalidates a challenge sent to a protected request if it receives apparently from the same user another request and if request is unprotected, the S-CSCF 36 may keep both challenges and waits for the response until the authentication timer 37 expires. The authentication timer may be set, for example, to run approximately 4 minutes.

In accordance with a further embodiment, if there are two outstanding challenges towards one user, one being for a unprotected request and another being for a protected request, and if yet another unprotected request is received, the challenge sent previously in response to the unprotected request may be invalidated. A new challenge may be sent to the freshly received unprotected registration request and the challenge sent previously to the protected request may be maintained as valid.

Similar behaviour may occur if there are two outstanding challenges towards one user, one for unprotected request and another for a protected request, and a protected registration request is received. In such a case a challenge sent previously to the protected request may be invalidated and a new challenge may be sent to the freshly received protected request. The challenge sent previously to the unprotected request may remain valid.

In the embodiments a user already registered with the network and willing to extend its registration timer by sending a protected re-register request to the network may be protected against an attacker trying to perform denial of service type attacks. Completion of authentication processes may be allowed to occur for all requests during re-registration. The attacker may not be able to force the network to invalidate a challenge sent to a protected request by issuing an unprotected request in the name of a genuine user. The embodiments may be transparent for the user equipment, and the necessary hardware and software may be provided in the network side.

The messaging may be based on the session initiation protocol (SIP). SIP was generally developed to allow for initiating a session between two or more endpoints in the Internet by making these endpoints aware of the session semantics. A user connected to a SIP based communication system may communicate with various entities of the communication system based on standardised SIP messages. User equipment or users that run certain applications on the user equipment are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. Examples of the possible sessions include Internet multimedia conferences, Internet telephone calls, and multimedia distribution.

If SIP messaging is used, a user equipment 30 requesting for registration sends a SIP ‘REGISTER’ message via the IMS system to the P-CSCF 35 and then to the S-CSCF 36.

It should be appreciated that whilst embodiments of the present invention have been described in relation to user equipment such as mobile stations, embodiments of the present invention are applicable to any other type of equipment that needs to be authenticated.

The examples of the invention have been described in the context of an IMS system and GPRS networks. However, this invention is also applicable to any other standards. Furthermore, the given examples are described in the context of the so called all SIP networks with all SIP entities and communication channels known as PDP contexts. This invention is also applicable to any other appropriate communication system, either wireless or fixed line systems, communication standards and communication protocols.

Examples of other possible communication systems enabling wireless data communication services, without limiting to these, include third generation mobile communication system such as the Universal Mobile Telecommunication System (UMTS), i-phone or CDMA2000 and the Terrestrial Trunked Radio (TETRA) system, the Enhanced Data rate for GSM Evolution (EDGE) mobile data network. Examples of fixed line systems include the diverse broadband techniques providing Internet access for users in different locations, such as at home and offices. Regardless the standards and protocols used for the communication network, the invention can be applied in all communication networks wherein registration in a network entity is required.

The embodiments of the invention have been discussed in the context of proxy and servicing call state control functions. Embodiments of the invention can be applicable to other network elements where applicable.

It is also noted herein that while the above describes exemplifying embodiments of the invention, there are several variations and modifications which may be made to the disclosed solution without departing from the scope of the invention as defined in the appended claims.

1. A method in a communication system for authentication of requests, the method comprising the steps of:
a) registering a user equipment to a controller, the registering step comprising authentication of the user equipment;
b) receiving, in the controller, at least two registration requests within a predetermined time, wherein at least one of the at least two registration requests originates from another source than the user equipment;
c) initiating authentication of the received at least two registration requests; and
d) registering the user equipment in response to a request from the user equipment authenticated in step a).

2. A method as claimed in claim 1, wherein the step of receiving the at least two registration requests comprises receiving a re-registration request for re-registration from the user equipment.

3. A method as claimed in claim 1, wherein the step of receiving the at least two registration requests comprises checking a protection state of the at least two registration requests.

4. A method as claimed in claim 1, further comprising the steps of:
challenging the at least two registration requests received at step b) with challenges;
initiating an authentication timer; and
waiting for response to the challenges until an expiry of the authentication timer.

5. A controller for a communication system, the controller configured:
to authenticate user equipments that have sent initial registration requests,
to receive at least two further registration requests, wherein at least one of the at least two further registration requests originates from another source than an authenticated user equipment,
to initiate authentication of the received at least two further registration requests, and
to register other user equipment in response to further requests from the authenticated user equipment.

6. A controller as claimed in claim 5, further comprising an authentication timer, the controller to wait for responses to challenges for said further registration requests until an expiry of the authentication timer.

7. A controller as claimed in claim 5, wherein the controller comprises a call state control function.

8. A controller as claimed in claim 5, wherein the controller checks a protection state of a received request.

9. A communication system for providing user equipments with services, the communication system comprising:
a controller configured to authenticate user equipments that have sent initial registration requests to the controller, to receive further registration requests, at least one of the further registration requests originating from another source than an authenticated user equipment, to initiate authentication of the received further registration requests, and to register user equipment in response to further requests from authenticated user equipment.

10. A communication system as claimed in claim 9, wherein the communication system comprises an internet multimedia subsystem.

11. A communication system as claimed in claim 10, wherein controller comprises a serving call state control function.

12. A communication system as claimed in claim 9, further comprising a second controller configured to include in a message from the user equipment an indication of a protection state of the message.

13. A computer program embodied on a computer readable medium having computer program code that when run on a computer executes steps for authentication of requests in a communication system, the steps comprising:
registering a user equipment to a controller, the registering step comprising authentication of the user equipment;
receiving, in the controller, at least two registration requests within a predetermined time, wherein at least one of the at least two registration requests originates from another source than the user equipment;
initiating authentication of the received at least two registration requests; and
registering the user equipment in response to a request from the use equipment authenticated in the registering step.

14. A controller for a communication system, the controller comprising:
authenticating means for authenticating user equipments that have sent initial registration requests;
receiving means for receiving at least two further registration requests, wherein at least one of the at least two further registration requests originates from another source than an authenticated user equipment;
initiating means for initiating authentication of the received at least two further registration requests; and
registering means for registering other user equipment in response to further requests for the authenticated user equipment.
